(19) United States
(12) Patent Application Publication
(10) Pub. No.: US 2026/0136227 A1
(43) Pub. Date: May 14, 2026

(54) INFORMATION TRANSCEIVING METHOD AND APPARATUS

(71) Applicant: FUJITSU LIMITED, Kawasaki-shi (JP)

(72) Inventors: Gang SUN, Beijing (CN); Xin WANG, Beijing (CN)

(73) Assignee: FUJITSU LIMITED, Kawasaki-shi (JP)

(21) Appl. No.: 19/441,942

(22) Filed: Jan. 7, 2026

Related U.S. Application Data
(63) Continuation of application No. PCT/CN2023/106280, filed on Jul. 7, 2023.

(51) Int. Cl. H04W 24/10

(52) U.S. Cl. CPC H04W 24/10

(57) ABSTRACT

An information transceiving apparatus, applicable to a network device, includes: a first transmitter configured to transmit first indication information to a terminal equipment or not to transmit first indication information to a terminal equipment, the first indication information being used to indicate a type of one or more reported results in a reporting instance transmitted by the terminal equipment; and a first receiver configured to receive the reporting instance transmitted by the terminal equipment.

### CROSS-REFERENCE TO RELATED APPLICATIONS

This application is a continuation application under 35 U.S.C. 111 (a) of International Patent Application PCT/CN2023/106280 filed on Jul. 7, 2023, and designated the U.S., the entire contents of which are incorporated herein by reference.

### TECHNICAL FIELD

This disclosure relates to the field of communication technologies.

### BACKGROUND

As low-frequency spectrum resources become scarce, the millimeter wave frequency band can provide greater bandwidth and has become an important frequency band for 5G New Radio (NR) systems. Millimeter waves have different propagation characteristics from legacy low-frequency bands due to its shorter wavelength, such as a higher propagation loss, poor reflection and diffraction performance, etc. Therefore, larger antenna arrays are usually used to form shaped beams with greater gain, which overcome propagation losses, and ensure system coverage. 5G NR standards have designed a series of solutions for beam management, including beam scanning, beam measurement, beam reporting, and beam indication, etc. However, when the number of transceiving beams is relatively large, a payload and latency of the system will be greatly increased. With the development of artificial intelligence (AI) technologies, applying the AI technologies to a physical layer of wireless communication to solve difficulties of legacy methods has become a current technological direction. For beam management, using AI models to predict a spatially optimal beam pair according to results of a small number of beam measurements may significantly reduce the payload and latency of the system.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It is assumed that a transmitting side of a communication system has M beams and a receiving side thereof has N beams, in existing standards, it is needed to measure M*N beams. When numbers of M and N are relatively large, measuring M*N beams will result in a relatively large system payload and relatively long latency. Using a model (such as an AI model) to predict an optimal beam pair from measurement results of a small number of beams may greatly reduce the system payload and latency caused by the beam measurement.

If an AI model is deployed at a terminal equipment side and a network device configures a reference signal set for beam measurement, the terminal equipment may measure reference signals in the reference signal set to obtain a measurement result, or may use the measurement result as an input to the AI model to obtain a prediction result. A result reported by the terminal equipment may be a measurement result or a prediction result. However, currently there is no method for distinguishing a type of a reported result by the terminal equipment and the network device.

In order to solve at least one of the above problems, embodiments of this disclosure provide an information transceiving method and apparatus.

According to one aspect of the embodiments of this disclosure, there is provided an information transceiving apparatus, applicable to a terminal equipment, the apparatus including:
a second receiving unit configured to receive reporting configuration transmitted by a network device; and
a second transmitting unit configured to transmit a reporting instance to the network device, the reporting instance comprising one or more reported results, a type of the one or more reported results comprising a measurement result and/or a prediction result.

According to another aspect of the embodiments of this disclosure, there is provided an information transceiving apparatus, applicable to a network device, the apparatus including:
a first transmitting unit configured to transmit first indication information to a terminal equipment or not to transmit first indication information to a terminal equipment, the first indication information being used to indicate a type of one or more reported results in a reporting instance transmitted by the terminal equipment; and
a first receiving unit configured to receive the reporting instance transmitted by the terminal equipment.

According to a further aspect of the embodiments of this disclosure, there is provided a communication system, including a terminal equipment and/or a network device, the terminal equipment including the information transceiving apparatus described in the one aspect, and the network device including the information transceiving apparatus described in the other aspect.

An advantage of the embodiments of this disclosure exists in that the network device configures the terminal equipment with the indication information for indicating a type/types of one or more reported results in the reporting instance transmitted by the terminal equipment, and the terminal equipment transmits the reporting instance according to the indication information. Hence, the terminal equipment and network device may distinguish the types of the results in the reporting instance.

Another advantage of the embodiments of this disclosure exists in that the terminal equipment may include the indication information for indicating a type/types of one or more reported results in the reporting instance, or determine a type/types of one or more reported results in the reporting instance in a predefined method. Hence, the terminal equipment and network device may distinguish the type of the results in the reporting instance.

With reference to the following description and drawings, the particular embodiments of this disclosure are disclosed in detail, and the principle of this disclosure and the manners of use are indicated. It should be understood that the scope of the embodiments of this disclosure are not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of embodiments of this disclosure;

FIG. 2 is a schematic diagram of an information transceiving method of embodiments of this disclosure;

FIG. 3 is a schematic diagram of an information transceiving method of embodiment of this disclosure;

FIG. 4 is a schematic diagram of an information transceiving method of embodiments of this disclosure;

FIG. 5 is a schematic diagram of an information transceiving method of embodiments of this disclosure;

FIG. 6 is a schematic diagram of an information transceiving method of embodiments of this disclosure;

FIG. 7 is a schematic diagram of an information transceiving method of embodiments of this disclosure;

FIG. 8 is a schematic diagram of an information transceiving apparatus of embodiments of this disclosure;

FIG. 9 is a schematic diagram of an information transceiving apparatus of embodiments of this disclosure;

FIG. 10 is a schematic diagram of a network device of embodiments of this disclosure; and

FIG. 11 is a schematic diagram of a terminal equipment of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, new radio (NR) and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: aa base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, high-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

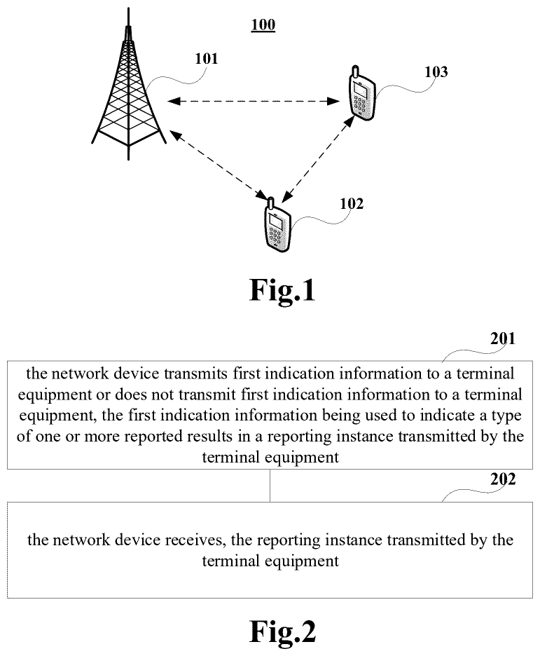

FIG. 1 is a schematic diagram of a communication system of embodiments of this disclosure, in which a case where terminal equipments and a network device are taken as examples is schematically shown. As shown in FIG. 1, the communication system 100 may include a network device 101 and terminal equipments 102, 103. For the sake of simplicity, an example having only two terminal equipments and one network device is schematically given in FIG. 1; however, the embodiments of this disclosure are not limited thereto.

In the embodiments of this disclosure, existing services or services that may be implemented in the future may be performed between the network device 101 and the terminal equipments 102, 103. For example, such services may include but not limited to an enhanced mobile broadband (eMBB), massive machine type communication (mMTC), and ultra-reliable and low-latency communication (URLLC), etc.

The terminal equipment 102 may transmit data to the network device 101, such as in a granted or grant-free transmission manner. The network device 101 may receive data transmitted by one or more terminal equipments 102 and feed back information to the terminal equipment 102, such as acknowledgement (ACK)/non-acknowledgement (NACK) information. According to the feedback information, the terminal equipment 102 may acknowledge end of a transmission process, or may perform new data transmission, or may perform data retransmission.

It should be noted that FIG. 1 shows that two terminal equipments 102, 103 are both in coverage of the network device 101. However, this disclosure is not limited thereto, and the two terminal equipments 102, 103 may not be in coverage of the network device 101, or one terminal equipment 102 is in coverage of the network device 101 and the other terminal equipment 103 is out of coverage of the network device 101.

An AI model (or an ML model) includes but is not limited to an input layer (input), multiple convolutional layers, a concatenation layer (concat), a fully connected layer (FC), and a quantizer, etc., and processing results of the multiple convolutional layers are merged in the concatenation layer. Reference may be made to existing techniques for a specific structure of the AI model, which shall not be repeated herein any further.

It was found by the inventors that in at least the following scenarios, the terminal equipment and network device need to distinguish types of reported results.

(I) When the AI model is deployed in a terminal equipment and used for an inference process, the network device configures the terminal equipment with reference signals for AI model inference, and the terminal equipment measures these reference signals to obtain actual measurement quantity corresponding to these reference signals, and inputs the actual measurement quantity into the AI model to obtain a prediction result of beams. The terminal equipment selects one or more prediction results according to its algorithm and reports them to the network device, and at this time, the result reported by the terminal is a prediction result. On the one hand, due to a problem of predicted performances, the reported prediction result may not be an optimal beam (pair). On the other hand, as the reported result is a prediction result, the terminal equipment may not have measured the beam (pair) to which the result corresponds, a reference signal carrying the beam (pair) is lack of corresponding quasi-colocation address (QCL) information. From the perspective of the terminal equipment, a TCI state with the reference signal as a source signal is unknown, for example, the reference signal does not have information on a QCL type D. Hence, in this scenario, for the reported result, the terminal equipment and network device need to clarify whether the reported result is a prediction result or an actual measurement result. When the reported result is a prediction result, the network device needs to transmit the reference signal to which the prediction result corresponds to the terminal equipment via the same beam used for prediction, including configuring a reference signal set again by the network device, the reference signal set including the reference signal to which the prediction result corresponds, or a reference signal to which a result in the prediction result that has not been actually measured corresponds, so that the terminal equipment actually measures these reference signals, and select one or more actual measurement results to report to the network device, so as to obtain corresponding QCL information.

(II) When an AI model is used for beam prediction, due to frequent changes in communication environment, if the AI model is not suitable for the current communication environment, a degradation on performance will happen. At this time, a legacy beam management method may be reused, or a AI model is reselected or retrained. In addition, if the system operates in a legacy beam management state, when the AI model is suitable for the current communication environment, the system may enter a state of using the AI model for beam prediction. The above process is dependent on performance monitoring of AI models in different communication environments. When the AI model is deployed in a terminal equipment, the network device calculates performance metrics of the model and makes decisions on subsequent actions of the model (such as back off to legacy beam management/model switching/model retraining, etc.) according to these metrics. The terminal equipment may report actual measurement quantity and corresponding beam (pair) information of one or more beams (pairs) to the network device, and may also report prediction measurement quantity and corresponding beam (pair) information of one or more beams (pairs) to the network device. The network device may calculate performance metrics (prediction errors of measurement quantity and/or a prediction accuracy of an optimal beam pair) according to contents reported by the terminal equipment. Hence, whether the reported result is a prediction result or an actual measurement result needs to be clarified between the terminal equipment and the network device.

However, currently there is no method for distinguishing a type of reported results by a terminal equipment and a network device.

In order to solve at least one of the above problems, embodiments of this disclosure provide an information transceiving method and apparatus, wherein a type of reported results is distinguished by the terminal equipment and the network device via additional signaling or in a predefined manner. Following description shall be given with reference to the accompanying drawings and embodiments.

### Embodiments of a First Aspect

The embodiments of this disclosure provide an information transceiving method and apparatus, which shall be described from a network device side. In the embodiments, a type of reported results is distinguished by a terminal equipment and a network device via additional signaling. More specifically, the network device configures indication information used to indicate a type of one or more reported results in a reporting instance transmitted by the terminal equipment, which shall be described below in detail.

FIG. 2 is a schematic diagram of the information transceiving method f of the embodiments of this disclosure. As shown in FIG. 2, the method includes:
201: the network device transmits first indication information to a terminal equipment or does not transmit first indication information to a terminal equipment, the first indication information being used to indicate a type of one or more reported results in a reporting instance transmitted by the terminal equipment; and
202: the network device receives, the reporting instance transmitted by the terminal equipment.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In some embodiments, the AI model for beam prediction is deployed in a terminal equipment, and when the network device configures a reference signal set for beam measurement for the terminal equipment, the terminal equipment may measure measurement quantity (such as L1-RSRP (reference signal receiving power) or an SINR (signal to interference plus noise ratio)) of beams (pairs) to which reference signals in the reference signal set correspond, and actual measurement quantity (hereinafter referred to as a measurement result) may be taken as input of the AI model. Types of the AI model include a regression model and a classification model. A prediction output by the regression model may be a prediction measurement quantity (such as LI-RSRP or an SINR) of M1×N1 beams (pairs), and a prediction output by the classification model may be a confidence (or probability) that a predicted beam (pair) is an optimal beam (pair). In addition, the output of the AI model may further include beam (pair) information corresponding to the prediction result (predicted measurement quantity or predicted confidence) (indicated by a reference signal identifier, such as a synchronization signal block resource indicator (SSB RI) or a channel state information reference signal resource indicator (CSI-RS resource indicator, CRI), and there exists a correspondence between the beam (pair) and the reference signal, and reference may be made to relevant techniques for details).

In some embodiments, first indication information may be newly designed, which is used to indicate the type of one or more reported results in the reporting instance transmitted by the terminal equipment, the type including the above measurement result or prediction result. That is, according to the first indication information, the network device may indicate to the terminal equipment whether the reported result is a prediction result or a measurement result.

In some embodiments, the network device may transmit the first indication information to the terminal equipment. When a value of the first indication information is a first value, it indicates that the reported result is a measurement result, and when a value of the first indication information is a second value, it indicates that the reported result is a prediction result. For example, the first indication information is represented by 1 bit, a first value of its numeral value is 0, and a second value thereof is 1, or vice versa, a first value of the numeral value being 1, and a second value of the numeral value being 0. After receiving the first indication information, the terminal equipment may determine whether to report a measurement result or a prediction result in a reporting instance according to a numeral value of the first indication information.

In some embodiments, the network device may transmit the first indication information or may not transmit the first indication information to the terminal equipment. When the first indication information is transmitted, it indicates that the reported result is a measurement result, and when the first indication information is not transmitted, it indicates that the reported result is a prediction result. That is, when the terminal equipment receives the first indication information, it determines to report a measurement result in a reporting instance, and when it does not receive the first indication information, it determines to report a prediction result in a reporting instance; or, when the first indication information is not transmitted, it indicates that the reported result is a measurement result, and when the first indication information is transmitted, it indicates that the report result is a prediction result. That is, when the terminal equipment receives the first indication information, it determines to report a prediction result in a reporting instance, and when it does not receive the first indication information, it determines to report a measurement result in a reporting instance.

In some embodiments, when the network device indicates the type of the reported result to the terminal equipment, such as indicating whether the reported result is a prediction result or a measurement result, a reporting instance includes only one type, that is, the reporting instance reported by the terminal equipment includes only a measurement result or a prediction result.

In some embodiments, when the first indication information is transmitted, the first indication information may be carried by radio resource control (RRC) signaling, or a media access control (MAC) control element (CE), or downlink control information (DCI), wherein the RRC signaling or the MAC CE or the DCI may be existing or newly added, and the embodiments of this disclosure are not limited thereto.

For example, for above scenario (I), the network device may transmit reference signal configuration information and beam measurement report configuration information used for AI model inference to the terminal equipment. The first indication information may be carried by the reference signal configuration information, or may be carried by the beam measurement report configuration information, or may be carried by newly-added signaling; however, the embodiments of this disclosure are not limited thereto. For example, when the first indication information is carried by the beam measurement report configuration information, an information field of 1 bit may be added to the beam measurement report configuration information. When a value of 1 bit is 0, it indicates reporting a measurement result, and when a value of 1 bit is 1, it indicates reporting a prediction result, and vice versa. Or, when the beam measurement report configuration information includes the first indication information, it indicates reporting a measurement result, and when the beam measurement report configuration information does not include the first indication information, it indicates reporting a prediction result, and vice versa, which shall not be enumerated herein any further.

For example, for above scenario (II), the network device may transmit reference signal configuration information and beam measurement report configuration information used for AI model performance monitoring to the terminal equipment. The first indication information may be carried by the reference signal configuration information, or may be carried by the beam measurement report configuration information, or may be carried by newly-added signaling; however, the embodiments of this disclosure are not limited thereto. For example, when the first indication information is carried by the beam measurement report configuration information, an information field of 1 bit may be added to the beam measurement report configuration information. When a value of 1 bit is 0, it indicates reporting a measurement result, and when a value of 1 bit is 1, it indicates reporting a prediction result, and vice versa. Or, when the beam measurement report configuration information includes the first indication information, it indicates reporting a measurement result, and when the beam measurement report configuration information does not include the first indication information, it indicates reporting a prediction result, and vice versa, which shall not be enumerated herein any further.

The above reference signal configuration information and report configuration information may further include other information, and reference may be made to relevant techniques for details; however, the embodiments of this disclosure are not limited thereto.

In some embodiments, in 202, the terminal equipment may determine a type of a reported result contained in a reporting instance according to whether the first indication information is received or according to a value of the received first indication information, and transmit the reporting instance to the network device. When there are multiple results to which the indicated type corresponds, the terminal equipment may select a part or all of the results of the type according to its algorithm to report to the network device, and reference may be made to relevant algorithms for details; however, the embodiments of this disclosure are not limited thereto.

In some embodiments, the reporting instance further includes one or more second indication information, the one or more second indication information being used to indicate type(s) of one or more reported results in the reporting instance transmitted by the terminal equipment. Reference may be made to embodiments of a third aspect for the second indication information, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiments, the network device configures the terminal equipment with the indication information for indicating a type of one or more reported results in the reporting instance transmitted by the terminal equipment, and the terminal equipment transmits the reporting instance according to the indication information. Hence, the terminal equipment and network device may distinguish the type of the results in the reporting instance.

### Embodiments of a Second Aspect

The embodiments of this disclosure provide an information transceiving method, which shall be described from a terminal equipment side, with contents identical to those in the embodiments of the first aspect being not going to be repeated herein any further.

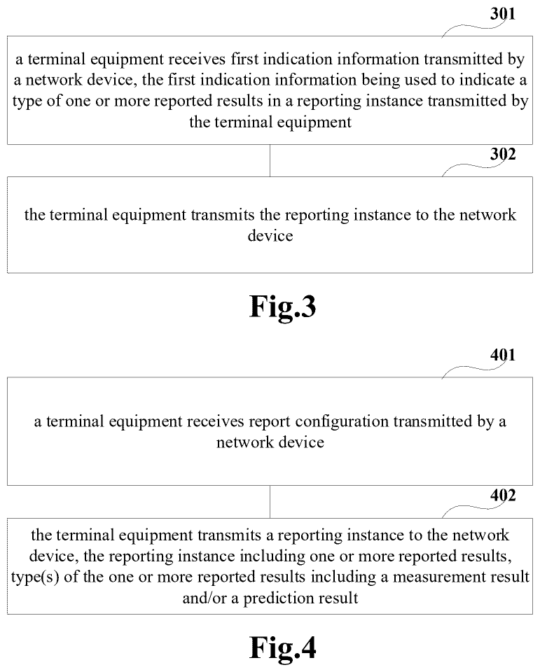

FIG. 3 is a schematic diagram of the information transceiving method of the embodiments of this disclosure. As shown in FIG. 3, the method includes:
301: a terminal equipment receives first indication information transmitted by a network device, the first indication information being used to indicate a type of one or more reported results in a reporting instance transmitted by the terminal equipment; and
302: the terminal equipment transmits the reporting instance to the network device.

It should be noted that FIG. 3 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

In some embodiments, implementations of 301-302 corresponds to those of 201-202, and reference may be made to the embodiments of the first aspect for implementations of the first indication information and the reporting instance, which shall not be repeated herein any further.

In some embodiments, in 301, the receiving by the terminal equipment the first indication information transmitted by the network device indicates “attempting to receive”, or “detecting”, etc., and does not indicate that the first indication information has been received (does not indicate receiving successfully or unsuccessfully). For example, the terminal equipment may attempt to receive the first indication information, and when the first indication information is received, it indicates that a reported result is a measurement result, and when the first indication information is not received, it indicates that a reported result is a prediction result, and vice versa. Or, it may also indicate that the terminal equipment receives the first indication information transmitted by the network device, and when a value of the first indication information is a first value, it indicates that a reported result is a measurement result, when a value of the first indication information is a second value, it indicates that a reported result is a prediction result. Reference may be made to the embodiments of the second aspect for details, which shall not be repeated herein any further.

In some embodiments, the reporting instance further includes one or more second indication information, the one or more second indication information being used to indicate type(s) of one or more reported results in the reporting instance transmitted by the terminal equipment. Reference may be made to the embodiments of the third aspect for the second indication information, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Third Aspect

The embodiments of this disclosure provide an information transceiving method, which shall be described from a terminal equipment side, an AI model being deployed in the terminal equipment.

FIG. 4 is a schematic diagram of the information transceiving method of the embodiments of this disclosure. As shown in FIG. 4, the method includes:
401: a terminal equipment receives report configuration transmitted by a network device; and
402: the terminal equipment transmits a reporting instance to the network device, the reporting instance including one or more reported results, type(s) of the one or more reported results including a measurement result and/or a prediction result.

It should be noted that FIG. 4 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 4.

In some embodiments, the reporting configuration may be as described in the embodiments of the first aspect, which may be the beam measurement reporting configuration in scenario I or the beam measurement reporting configuration for performance monitoring in scenario II. The reporting configuration may include a reporting period, and a measurement quantity (RSRP or an SINR), etc., and reference may be made to relevant techniques for details, which shall not be repeated herein any further.

In some embodiments, the terminal equipment may perform beam measurement and beam prediction according to the reference signal configured by the network device to obtain a beam measurement result and beam prediction result, and contain one or more reported results in the reporting instance according to an algorithm. Type(s) of the one or more reported results include(s) a measurement result and/or a prediction result, and reference may be made to the embodiments of the first aspect for definitions of the measurement result and prediction result. The reporting instance further includes a reference signal identifier, a type of a reported result to which the reference signal identifier corresponds including a measurement result, or a prediction result, or a measurement result and a prediction result. The reference signal identifier may be, for example, the SSB RI or CRI described above, and a beam (pair) may be implicitly indicated by the reference signal identifier. The reference signal corresponds to the reported result, that is, the reported result is a measurement result obtained by measuring the reference signal (beam), or a prediction result to which the reference signal (beam) output by the AI model corresponds.

(I) In some embodiments, the types of the reported results are distinguished between the terminal equipment and the network device by additional signaling, wherein the network device configures the terminal equipment with indication information used for indicating the type(s) of the one or more reported results in the reporting instance transmitted by the terminal equipment. One reporting instance only includes one type of result, that is, the reporting instance reported by the terminal equipment includes only a measurement result or includes only a prediction result. In this embodiment, the reporting configuration may include the above first indication information (or the first indication information may also be carried by other signaling). Optionally, the reporting instance may further include second indication information. Reference may be made to the embodiments of the first aspect for specific implementation of (I), and the embodiments of the first and second aspects may be incorporated herein, which shall not be repeated herein any further.

(II) In some embodiments, the types of the reported results are distinguished between the terminal equipment and the network device by additional signaling, wherein the terminal equipment includes second indication information used for indicating type(s) of one or more reported results transmitted by the terminal equipment in the reporting instance. A reporting instance may include one type of result or may simultaneously include two types of results. A difference from (I) exists in that a reporting instance may simultaneously include two types of results, in which case the network device is not needed to configure the first indication information, which shall be described below in detail.

In some embodiments, the reporting instance may include one or more second indication information for indicating the types of the one or more reported results transmitted by the terminal equipment in the reporting instance, wherein the terminal equipment may provide indication information for all reported results in a reporting instance, or provide indication information for one or a group of reported results in a reporting instance, or provide indication information for one or a group of beams (reference signals) in a reporting instance.

In some embodiments, the reporting instance includes one second indication information, the second indication information corresponding to one group of reported results or all reported results, or the reporting instance includes multiple second indication information, each second indication information in the multiple second indication information corresponding to a reported result, and the number of the second indication information being less than or equal to the number of the reported results, and/or,
the reporting instance includes one second indication information, one second indication information corresponding to one group of reference signal identifiers or all reference signal identifiers, or the reporting instance includes multiple second indication information, each second indication information in the multiple second indication information corresponding to a reference signal identifier, and the number of the second indication information being less than or equal to the number of the reference signal identifiers.

In some embodiments, when a value of the second indication information is a first value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are measurement result(s), and when a value of the second indication information is a second value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are prediction result(s). The first value is 0, and the second value is 1, or the second value is 0, and the second value is 1.

In some embodiments, when the value of the second indication information is the first value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are measurement result(s), and the remaining reported results (not corresponding to the second indication information) or the reported results to which the reference signal identifiers correspond are prediction results; or, when the value of the second indication information is the first value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are prediction result(s), and the remaining reported results (not corresponding to the second indication information) or the reported results to which the reference signal identifiers correspond are measurement results.

Following description shall be given by way of examples.

For example, the terminal equipment may provide the indication information for all reported results in a reporting instance. The number of the second indication information is identical to the number of the reported results in a reporting instance. One second indication information corresponds to one reported result, that is, each second indication information is used to indicate a type of one reported result, or, in other words, each reported result has corresponding second indication information. When the number of the reported results is N, the number of the second indication information is N, and N is greater than or equal to 1. For example, the second indication information may be represented by 1 bit, and N bits are newly added to the reporting instance to indicate types of the reported results, as shown in Table 1 below. The reporting instance includes 4 beams (pairs), i.e. 4 SSB-RI/CRIs, each beam (pair) corresponds to 2 reported results, i.e. a measurement result and a prediction result. For example, SSB-RI/CRI #1 corresponds to reported results L1-RSRP #1-1 and L1-RSRP #1-2. When a bit value of the second indication information is the first value, it indicates that L1-RSRP corresponding to the second indication information is a measurement result, and when a bit value of the second indication information is the second value, it indicates that L1-RSRP corresponding to the second indication information is a prediction result.

TABLE 1
SSB-RI/CRI #1
SSB-RI/CRI #2
SSB-RI/CRI #3
SSB-RI/CRI #4

| | |
|---|---|
| Indication | L1-RSRP #1-1 |
| information | |
| Indication | L1-RSRP #1-2 |
| information | |
| Indication | L1-RSRP #2-1 |
| information | |
| Indication | L1-RSRP #2-2 |
| information | |
| Indication | L1-RSRP #3-1 |
| information | |
| Indication | L1-RSRP #3-2 |
| information | |
| Indication | L1-RSRP #4-1 |
| information | |
| Indication | L1-RSRP #4-2 |
| information | |

For example, the terminal equipment may provide indication information for a part of reported results in a reporting instance, or, in other words, only a part of reported results have corresponding second indication information. The number of the second indication information is less than the number of reported results in a reporting instance, and one second indication information corresponds to one reported result. For example, a reporting instance includes N reported results and M second indication information; where, M is less than N, M is greater than or equal to 1, the M second indication information indicate types of M reported results in the N reported results, M second indication information correspond one-to-one with M reported results, and the remaining (N-M) reported results do not have corresponding second indication information. For example, the second indication information may be represented by 1 bit, and M bits are added to the reporting instance to indicate types of the M reported results. When a value of the second indication information is the first value, it indicates that a corresponding reported result is a measurement result, and the remaining reported results (not corresponding to the second indication information) are prediction results, and vice versa. As shown in Table 2 below, the reporting instance includes four beams (pairs), i.e. four SSB-RI/CRIs, each beam (pair) corresponds to two reported results, i.e. a measurement result and a prediction result. For example, SSB-RI/CRI #1 corresponds to reported results L1-RSRP #1-1 and L1-RSRP #1-2, wherein L1-RSRP #1-1, L1-RSRP #2-1, L1-RSRP #3-1 and L1-RSRP #4-1 have corresponding second indication information, and the remaining reported results do not have corresponding second indication information. When a bit value of the second indication information is the first value, it indicates that L1-RSRP #1-1, L1-RSRP #2-1, L1-RSRP #3-1 and L1-RSRP #4-1 corresponding to the second indication information are measurement results, while the remaining L1-RSRP #1-2, L1-RSRP #2-2, L1-RSRP #3-2 and L1-RSRP #4-2 are prediction results, and vice versa.

TABLE 2
SSB-RI/CRI #1
SSB-RI/CRI #2
SSB-RI/CRI #3
SSB-RI/CRI #4

| | |
|---|---|
| Indication | L1-RSRP #1-1 |
| information | |
| | L1-RSRP #1-2 |
| Indication | L1-RSRP #2-1 |
| information | |
| | L1-RSRP #2-2 |
| Indication | L1-RSRP #3-1 |
| information | |
| | L1-RSRP #3-2 |
| Indication | L1-RSRP #4-1 |
| information | |
| | L1-RSRP #4-2 |

In some embodiments, the reporting instance further includes group identifiers corresponding to the reported results, and types of reported results to which different groups of reported results correspond are different. That is, reporting may be performed in a form of grouping. For example, prediction results are in a group, measurement results are in another group, and all results in the groups are either measurement results or prediction results. The reporting instance contains one second indication information, which corresponds to a group of reported results, that is, types of all reported results may be indicated by one second indication information. When the value of the second indication information is the first value, it indicates that a corresponding group of reported results are measurement results, and a remaining group of reported results are prediction results, and vice versa. As shown in Table 3 below, the reporting instance includes four beams (pairs), i.e. four SSB-RI/CRIs, each beam (pair) corresponding to two reported results, namely, a measurement result and a prediction result. For example, SSB-RI/CRI #1 corresponds to reported results L1-RSRP #1-1, L1-RSRP #1-2, wherein a group identifier to which L1-RSRP #1-1, L1-RSRP #2-1, L1-RSRP #3-1 and L1-RSRP #4-1 correspond is group 1, and a group identifier to which the remaining reported results correspond is group 2. When the bit value of the second indication information is the first value, it indicates that L1-RSRP #1-1, L1-RSRP #2-1, L1-RSRP #3-1 and L1-RSRP #4-1 in group 1 corresponding to the second indication information are measurement results, and the remaining L1-RSRP #1-2, L1-RSRP #2-2, L1-RSRP #3-2 and L1-RSRP #4-2 in group 2 are prediction results. When the bit value of the second indication information is the second value, it indicates that L1-RSRP #1-1, L1-RSRP #2-1, L1-RSRP #3-1 and L1-RSRP #4-1 in group 1 corresponding to the second indication information are prediction results, and the remaining L1-RSRP #1-2, L1-RSRP #2-2, L1-RSRP #3-2 and L1-RSRP #4-2 in group 2 are measurement results, and vice versa.

TABLE 3
Indication information
SSB-RI/CRI #1
SSB-RI/CRI #2
SSB-RI/CRI #3
SSB-RI/CRI #4
L1-RSRP #1-1, group 1
L1-RSRP #1-2, group 2
L1-RSRP #2-1, group 1
L1-RSRP #2-2, group 2
L1-RSRP #3-1, group 1
L1-RSRP #3-2, group 2
L1-RSRP #4-1, group 1
L1-RSRP #4-2, group 2

For example, the terminal equipment may provide indication information for all reference signal identifiers in a reporting instance. The number of the second indication information is identical to the number of reference signal identifiers in a reporting instance. One second indication information corresponds to one reference signal identifier, that is, each second indication information is used to indicate a type of a reported result to which one reference signal identifier corresponds, or, in other words, each reference signal identifier has corresponding second indication information. When there are N reference signal identifiers, the number of the second indication information is N; where, N is greater than or equal to 1. For example, the second indication information may be represented by 1 bit, and N bits are newly added to the reporting instance to indicate the types of the reported results to which the reference signal identifiers correspond. As shown in Table 4 below, the reporting instance includes 4 beams (pairs), i.e. 4 SSB-RI/CRIs, which are 2 optimal measurement beams and 2 optimal prediction beams, corresponding respectively to a second indication information, each beam (pair) corresponding to a reported result (a prediction result or a measurement result). When a bit value of second indication information to which SSB-RI/CRI #1 corresponds is the first value, it indicates that L1-RSRP #1 to which SSB-RI/CRI #1 corresponds is a measurement result, and when the bit value of the second indication information is the second value, it indicates that L1-RSRP #1 corresponding to SSB-RI/CRI #1 is a prediction result.

TABLE 4

| | |
|---|---|
| Indication | SSB-RI/CRI #1 |
| information | |
| Indication | SSB-RI/CRI #2 |
| information | |
| Indication | SSB-RI/CRI #3 |
| information | |
| Indication | SSB-RI/CRI #4 |
| information | |

L1-RSRP #1
L1-RSRP #2
L1-RSRP #3
L1-RSRP #4

For example, the terminal equipment may provide indication information for a part of reference signals in a reporting instance, or, in other words, only a part of reference signals have corresponding second indication information, and the number of the second indication information is less than the number of reference signal identifiers in a reporting instance, one second indication information corresponding to one reference signal identifier. For example, a reporting instance includes N reference signals and M second indication information; where, M is less than N, and M is greater than or equal to 1. The M second indication information indicate types of reported results to which M reference signals in the N reference signals correspond, the M second indication information correspond one-to-one with M reference signals, and the remaining (N-M) reference signals do not have corresponding second indication information. For example, the second indication information may be represented by 1 bit, and M bits are newly added to the reporting instance to indicate types of reported results to which the M reference signals correspond. When a value of the second indication information is the first value, it indicates that a reported result to which a reference signal corresponds is a measurement result, and reported results to which the remaining reference signals (not corresponding to the second indication information) correspond are prediction results, and vice versa. As shown in Table 5 below, the reporting instance includes four beams (pairs), i.e. four SSB-RI/CRIs, which are two optimal measurement beams and two optimal prediction beams, each beam (pair) corresponding to a reported result (a measurement result or a prediction result), wherein SSB-RI/CRI #1 and SSB-RI/CRI #2 have corresponding second indication information, and the remaining reference signals do not have corresponding second indication information. When a bit value of the second indication information is the first value, it indicates that L1-RSRP #1 and L1-RSRP #2 corresponding to the second indication information are measurement results, and remaining L1-RSRP #3 and L1-RSRP #4 are prediction results, and when a bit value of the second indication information is the second value, it indicates that L1-RSRP #1 and L1-RSRP #2 corresponding to the second indication information are prediction results, and remaining L1-RSRP #3 and L1-RSRP #4 are measurement results, and vice versa.

TABLE 5

| | |
|---|---|
| Indication | SSB-RI/CRI #1 |
| information | |
| Indication | SSB-RI/CRI #2 |
| information | |
| | SSB-RI/CRI #3 |
| | SSB-RI/CRI #4 |

L1-RSRP #1
L1-RSRP #2
L1-RSRP #3
L1-RSRP #4

In some embodiments, the reporting instance further includes group identifiers corresponding to the reference signal identifiers, and types of reported results to which different groups of reference signal identifiers correspond are different. That is, reporting may be performed in a form of grouping. For example, prediction results are in a group, measurement results are in another group, and all results in the groups are either measurement results or prediction results. The reporting instance contains one second indication information, which corresponds to a group of reference signal identifiers, that is, types of all reported results may be indicated by one second indication information. When the value of the second indication information is the first value, it indicates that reported results to which a corresponding group of reference signal identifiers correspond are measurement results, and reported results to which a remaining group of reference signal identifiers correspond are prediction results, and vice versa. As shown in Table 6 below, the reporting instance includes two groups of reference signal identifiers and reported results to which the reference signals correspond, the two groups of reference signal identifiers corresponding respectively to an optimal measurement beam (pair) and an optimal prediction beam (pair). Each group of reference signal identifiers includes 2 SSB-RI/CRIs and reported results corresponding thereto, wherein a group identifier to which SSB-RI/CRI #1 and SSB-RI/CRI #3 correspond is group 1, and a group identifier to which the remaining SSB-RI/CRIs correspond is group 2. When a bit value of the second indication information is the first value, it indicates that L1-RSRP #1 and L1-RSRP #3 to which SSB-RI/CRI #1 and SSB-RI/CRI #3 in group 1 corresponding to the second indication information respectively correspond are measurement results, and L1-RSRP #2 and L1-RSRP #4 to which SSB-RI/CRI #2 and SSB-RI/CRI #4 in remaining group 2 respectively correspond are prediction results, and when the bit value of the second indication information is the second value, it indicates that L1-RSRP #1 and L1-RSRP #3 to which SSB-RI/CRI #1 and SSB-RI/CRI #3 in group 1 corresponding to the second indication information respectively correspond are prediction results, and L1-RSRP #2 and L1-RSRP #4 to which SSB-RI/CRI #2 and SSB-RI/CRI #4 in remaining group 2 respectively correspond are measurement results, and vice versa.

TABLE 6
Indication information

SSB-RI/CRI #1, group 1
SSB-RI/CRI #2, group 2
SSB-RI/CRI #3, group 1
SSB-RI/CRI #4, group 2
L1-RSRP #1
L1-RSRP #2
L1-RSRP #3
L1-RSRP #4

For example, the reporting instance includes one second indication information, the second indication information indicating types of all reported results or types of reported results to which all reference signal identifiers in the reporting instance correspond. In this example, the types of all the reported results in the reporting instance are identical. For example, the second indication information may be represented by 1 bit, and 1 bit is newly added to the reporting instance to indicate the types of all the reported results. As shown in Table 7 below, the reporting instance includes 4 beams (pairs), i.e. 4 SSB-RI/CRIs, each beam (pair) corresponding to a reported result, L1-RSRP #1, L1-RSRP #2, L1-RSRP #3, L1-RSRP #4. When a bit value of the second indication information is the first value, it indicates that all L1-RSRP is measurement results, and when the bit value of the second indication information is the second value, it indicates that all L1-RSRP is prediction results, and vice versa.

TABLE 7
Indication information

SSB-RI/CRI #1
SSB-RI/CRI #2
SSB-RI/CRI #3
SSB-RI/CRI #4
L1-RSRP #1
L1-RSRP #2
L1-RSRP #3
L1-RSRP #4

It should be noted that the above description is given by taking four beams as examples; however, the embodiments of this disclosure are not limited thereto. In addition, numerical values of L1-RSRP (which may also be SINRs) reported simultaneously may also be reported in differential form. For example, reporting is performed by calculating differences between other numerical values by taking L1-RSRP #1-1 (assuming that it is a maximum value of all results in the reporting instance) as a reference; however, it is not limited in this disclosure.

In addition, in the above examples, that each reference signal corresponds to one prediction result and/or one measurement result is taken as an example; however, the embodiments of this disclosure are not limited thereto, and each reference signal may correspond to multiple prediction results and/or multiple measurement results, or may correspond only to prediction results or measurement results. For example, for scenario (II), when the network device side takes a beam prediction accuracy as a performance metric, the terminal equipment may simultaneously include one or more predicted or measured beams (pairs) and their corresponding measurement results or prediction results in a reporting instance. For example, the terminal reports M measured optimal beams (pairs) and their corresponding measurement results, and N predicted optimal beams (pairs) and their corresponding prediction results, and at this time, the reporting instance includes SSB-RI/CRIs to which the beams (pairs) correspond and their corresponding measurement or prediction results, instead of including measurement results and prediction results (as shown in Table 4; however, it is not limited thereto). For example, for scenario (II), when the network device takes a prediction error as a performance metric, the terminal equipment may include one or more predicted or measured beams (pairs) and their corresponding measurement results and prediction results in a reporting instance (as shown in tables 1-3; however, it is not limited thereto).

(III) In some embodiments, there is no need to distinguish types of reported results between the terminal equipment and the network device via additional signaling, instead, the types of the reported results are distinguished in a predefined manner. A reporting instance may include one type of result, or may include two types of results at the same time (reference may be made to (II) for details, which shall not be repeated herein any further), which shall be described below in detail.

In some embodiments, a type/types of a reported result or a group of reported results in the one or more reported results is/are predefined as a measurement result/measurement results or a prediction result/prediction results, and/or a type/types of a reported result/reported results corresponding to a reference signal identifier or a group of reference signal identifiers is/are predefined as a measurement result/measurement results or a prediction result/prediction results, wherein the reporting instance further includes group identifiers corresponding to the reported results, and/or group identifiers corresponding to the reference signal identifiers. Specific implementations are as described above, and types of reported results to which different groups of reported results and/or different groups of reference signal identifiers correspond are different.

For example, for the reporting instance in Table 3, the second indication information may not be included, and a predefined method may be used to indicate whether types of a group of reported results are measurement results or prediction results. For example, it is predefined that reported results in group 1 are prediction results, while reported result in another group, i.e. group 2, are measurement results, or, it is predefined that reported results in group 1 are measurement results, while reported result in another group, i.e. group 2, are prediction results.

For example, for the reporting instance in Table 5, the second indication information may not be included, and a predefined method may be used to indicate whether types of reported results to which a group of beams (pairs) correspond are measurement results or prediction results. For example, it is predefined that reported results to which reference signal identifiers correspond in group 1 are prediction results, while reported result to which reference signal identifiers correspond in another group, i.e. group 2, are measurement results, or, it is predefined that reported results to which reference signal identifiers correspond in group 1 are measurement results, while reported result to which reference signal identifiers correspond in another group, i.e. group 2, are prediction results.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiments, the terminal equipment may include the indication information for indicating a type/types of one or more reported results in the reporting instance, or determine a type/types of one or more reported results in the reporting instance in a predefined method. Hence, the terminal equipment and network device may distinguish the type/types of the results in the reporting instance.

### Embodiments of a Fourth Aspect

The embodiments of this disclosure provide an information transceiving method, which shall be described from a network device side, with contents identical to those in the embodiments of the second aspect being not going to be repeated herein any further.

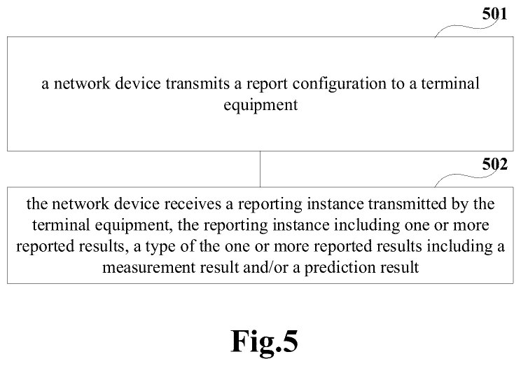

FIG. 5 is a schematic diagram of the information transceiving method of the embodiments of this disclosure. As shown in FIG. 5, the method includes:
501: a network device transmits a report configuration to a terminal equipment;
502: the network device receives a reporting instance transmitted by the terminal equipment, the reporting instance including one or more reported results, a type of the one or more reported results including a measurement result and/or a prediction result.

It should be noted that FIG. 5 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

In some embodiments, implementations of 501-502 corresponds to those of 401-402, and reference may be made to the embodiments of the first to third aspects for details, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

The information transceiving methods between the terminal equipment and the network device in the embodiments of the first to fourth aspects are as described below.

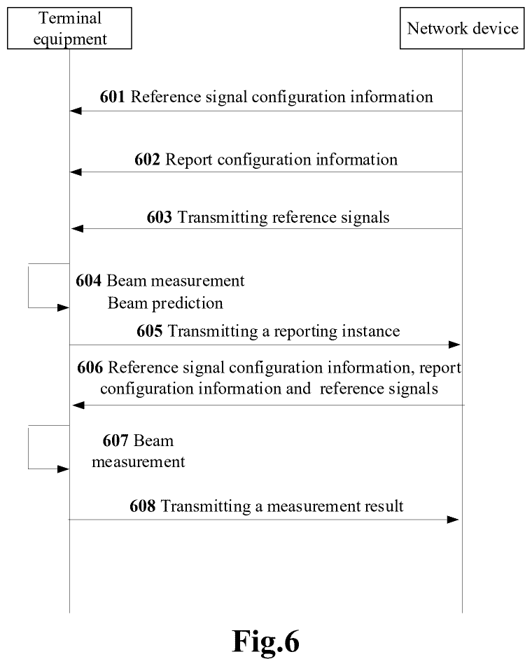

FIG. 6 is a schematic diagram of an information transceiving method in scenario I of embodiments of this disclosure. As shown in FIG. 6, the method includes:
601: a network device transmits reference signal configuration information for AI model inference to a terminal equipment;
602: the network device transmits beam measurement report configuration information to the terminal equipment;
603: the network device transmits reference signals in reference signal set to the terminal equipment;
604: the terminal equipment performs beam measurement by using the reference signals and performing beam prediction by using an AI model;
605: the terminal equipment transmits a reporting instance to the network device;
606: the network device determines a prediction result from the reporting instance, reconfiguring reference signal configuration information to which the prediction result corresponds (which has not been actually measured), and transmits beam measurement report configuration information and configured reference signals;
607: the terminal equipment performs beam measurement by using the reference signals; and
608: the terminal equipment transmits a measurement result to the network device.

In one implementation, the first indication information may be carried in the reference signal configuration information in 601 or the beam measurement reporting configuration information in 602, or the first indication information may be transmitted by using newly-added signaling before 605, and optionally, in 605, the reporting instance may carry the second indication information. In 606, the network device may distinguish a type of the reported result from the reporting instance according to the above-described first indication information or second indication information.

In one implementation, the second indication information may be carried only in the reporting instance in 605, and the network device may distinguish a type of the reported result from the reporting instance in 605 according to the second indication information.

In one implementation, no additional signaling may be added, and the network device may distinguish a type of the reported result from the reporting instance in 605 in a predefined manner.

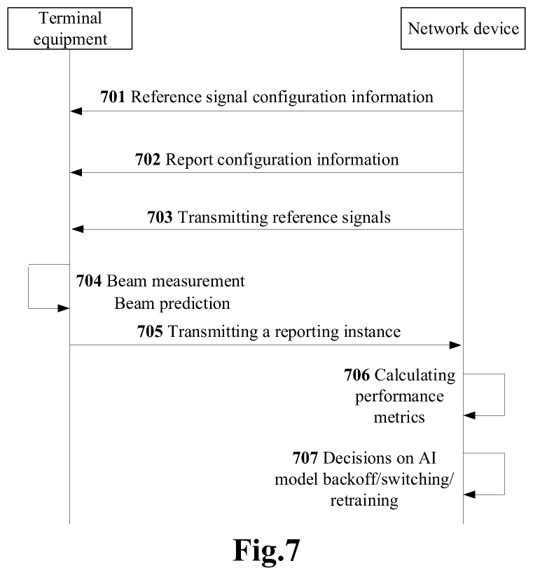

FIG. 7 is a schematic diagram of an information transceiving method in scenario II of embodiments of this disclosure. As shown in FIG. 7, the method includes:
701: a network device transmits reference signal configuration information for performance monitoring to a terminal equipment;
702: the network device transmits beam measurement report configuration information to the terminal equipment;
703: the network device transmits reference signals in the reference signal set to the terminal equipment;
704: the terminal equipment performs beam measurement by using the reference signals and performs beam prediction by using an AI model;
705: the terminal equipment transmits a reporting instance to the network device;
706: the network device determines a prediction result and a measurement result from the reporting instance, and calculates performance metrics according to the prediction result and the measurement result; and
707: the network device makes decisions on AI model backoff/switching/retraining according to the performance metrics.

In one implementation, the first indication information may be carried in the reference signal configuration information in 701 or the beam measurement reporting configuration information in 702, or the first indication information may be transmitted by using newly-added signaling before 705, and optionally, in 705, the second indication information may be carried in the reporting instance. In 706, the network device may distinguish a type of the reported result from the reporting instance according to the above-described first indication information or second indication information.

In one implementation, the second indication information may be carried only in the reporting instance in 705, and the network device may distinguish a type of the reported result from the reporting instance in 706 according to the second indication information.

In one implementation, no additional signaling may be added, and the network device may distinguish a type of the reported result from the reporting instance in 706 in a predefined manner.

### Embodiments of a Fifth Aspect

The embodiments of this disclosure provide an information transceiving apparatus. The apparatus may be, for example, a terminal equipment, or may be one or some components or assemblies configured in the terminal equipment, with contents identical to those in the embodiments of the second or third aspect being not going to be described herein any further.

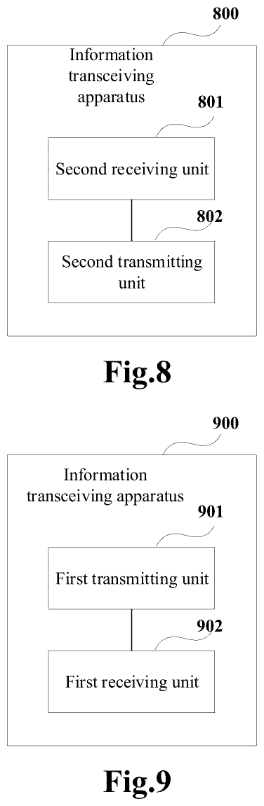

FIG. 8 is a schematic diagram of the information transceiving apparatus for receiving and transmitting information of the embodiments of this disclosure. As shown in FIG. 8, the apparatus 800 for receiving and transmitting information includes:
a second receiving unit 801 configured to receive reporting configuration transmitted by a network device; and
a second transmitting unit 802 configured to transmit a reporting instance to the network device, the reporting instance including one or more reported results, a type of the one or more reported results including a measurement result and/or a prediction result; or
a second receiving unit 801 configured to receive first indication information transmitted by a network device, the first indication information being used to indicate a type of one or more reported results in a reporting instance transmitted by the terminal equipment; and
a second transmitting unit 802 configured to transmit the reporting instance to the network device.

In some embodiments, reference may be made to the embodiments of the second or third aspect for implementations of the second receiving unit 801 and the second transmitting unit 802, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 800 may further include other components or modules, and reference may be made to related techniques for particulars of these components or modules.

Furthermore, for the sake of simplicity, connection relationships between the components or modules or signal profiles thereof are only illustrated in FIG. 8. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Sixth Aspect

The embodiments of this disclosure provide an information transceiving apparatus. The apparatus may be, for example, a network device, or may be one or some components or assemblies configured in the network device, with contents identical to those in the embodiments of the first or fourth aspect being not going to be described herein any further.

FIG. 9 is a schematic diagram of the information transceiving apparatus of the embodiments of this disclosure. As shown in FIG. 9, the information transceiving apparatus 900 includes:
a first transmitting unit 901 configured to transmit first indication information to a terminal equipment or not to transmit first indication information to a terminal equipment, the first indication information being used to indicate a type of one or more reported results in a reporting instance transmitted by the terminal equipment; and
a first receiving unit 902 configured to receive the reporting instance transmitted by the terminal equipment; or
a first transmitting unit 901 configured to transmit a report configuration to a terminal equipment; and
a first receiving unit 902 configured to receive a reporting instance transmitted by the terminal equipment, the reporting instance including one or more reported results, a type of the one or more reported results comprising a measurement result and/or a prediction result.

In some embodiments, reference may be made to the embodiments of the first or fourth aspect for implementations of the first transmitting unit 901 and the first receiving unit 902, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 900 may further include other components or modules, and reference may be made to related techniques for particulars of these components or modules.

Furthermore, for the sake of simplicity, connection relationships between the components or modules or signal profiles thereof are only illustrated in FIG. 9. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Seventh Aspect

The embodiments of this disclosure provide a communication system, and reference may be made to FIG. 1, with contents identical to those in the embodiments of the first to the sixth aspects being not going to be described herein any further.

In some embodiments, the communication system 100 may at least include a network device 101 and/or a terminal equipment 102, the network device 101 including the information transceiving apparatus 1300 in the embodiments of the fifth aspect, and the terminal equipment 102 including the information transceiving apparatus 1200 in the embodiments of the sixth aspect, which shall not be repeated herein any further.

The embodiments of this disclosure further provide a network device, which may be, for example, a base station. However, this disclosure is not limited thereto, and it may also be another network device.

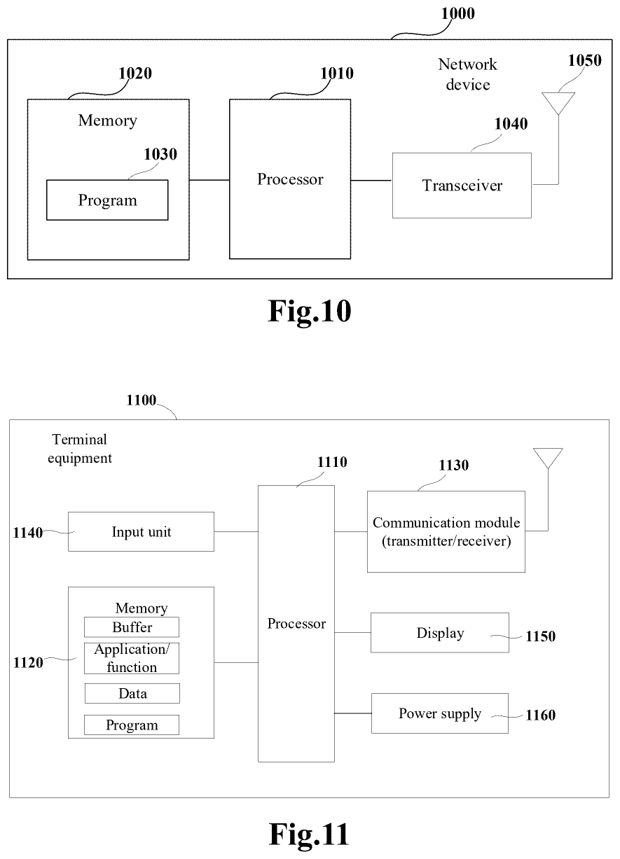

FIG. 10 is a schematic diagram of a structure of the network device of the embodiments of this disclosure. As shown in FIG. 10, the network device 1000 may include a processor 1010 (such as a central processing unit (CPU)) and a memory 1020, the memory 1020 being coupled to the processor 1010. Wherein, the memory 1020 may store various data, and furthermore, it may store a program 1030 for information processing, and execute the program 1030 under control of the processor 1010.

For example, the processor 1010 may be configured to execute a program to carry out the information transceiving method in the embodiments of the first or fourth aspect.

Furthermore, as shown in FIG. 10, the network device 1000 may include a transceiver 1040, and an antenna 1050, etc. Wherein, functions of the above components are similar to those in the related art, and shall not be described herein any further. It should be noted that the network device 1000 does not necessarily include all the parts shown in FIG. 10, and furthermore, the network device 1000 may include parts not shown in FIG. 10, and the related art may be referred to.

The embodiments of this disclosure further provide a terminal equipment; however, this disclosure is not limited thereto, and it may also be another equipment.

FIG. 11 is a schematic diagram of the terminal equipment of the embodiments of this disclosure. As shown in FIG. 11, the terminal equipment may include a processor 1110 and a memory 1120, the memory 1120 storing data and a program and being coupled to the processor 1110. It should be noted that this figure is illustrative only, and other types of structures may also be used, so as to supplement or replace this structure and achieve a telecommunications function or other functions.

For example, the processor 1110 may be configured to execute a program to carry out the information transceiving method in the embodiments of the second or third aspect.

As shown in FIG. 11, the terminal equipment 1100 may further include a communication module 1130, an input unit 1140, a display 1150, and a power supply 1160; wherein functions of the above components are similar to those in the related art, which shall not be described herein any further. It should be noted that the terminal equipment 1100 does not necessarily include all the parts shown in FIG. 11, and the above components are not necessary. Furthermore, the terminal equipment 1100 may include parts not shown in FIG. 11, and the related art may be referred to.

Embodiments of this disclosure provide a computer program, which, when executed in a terminal equipment, will cause the terminal equipment to carry out the information transceiving method as described in the embodiments of the second or third aspect.

Embodiments of this disclosure provide a storage medium, including a computer program, which will cause a terminal equipment to carry out the information transceiving method as described in the embodiments of the second or third aspect.

Embodiments of this disclosure provide a computer program, which, when executed in a network device, will cause the network device to carry out the information transceiving method as described in the embodiments of the first or fourth aspect.

Embodiments of this disclosure provide a storage medium, including a computer program, which will cause a network device to carry out the information transceiving method as described in the embodiments of the first or fourth aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to implementations containing the above embodiments, following supplements are further disclosed.
1. An information transceiving method, applicable to a network device, characterized in that the method includes:
transmitting first indication information to a terminal equipment or not transmitting first indication information to a terminal equipment, the first indication information being used to indicate a type of one or more reported results in a reporting instance transmitted by the terminal equipment; and
receiving the reporting instance transmitted by the terminal equipment.
2. The method according to supplement 1, wherein the type of the reported result includes a measurement result or a prediction result.
3. The method according to supplement 2, wherein the prediction result is obtained by an AI model deployed at a side of the terminal equipment.
4. The method according to supplement 1, wherein the first indication information is carried by RRC signaling and/or an MAC CE and/or DCI.
5. The method according to supplement 1, wherein the reporting instance further includes one or more second indication information, the one or more second indication information being used to indicate the type of the one or more reported results in the reporting instance transmitted by the terminal equipment.
6. The method according to supplement 1, wherein when the first indication information is transmitted, it is indicated that the report result is a measurement result, and when the first indication information is not transmitted, it is indicated that the report result is a prediction result; or, when the first indication information is not transmitted, it is indicated that the report result is a measurement result, and when the first indication information is transmitted, it is indicated that the report result is a prediction result; or, when the first indication information is transmitted and a value of the first indication information is a first value, it is indicated that the report result is a measurement result, and when the first indication information is transmitted and a value of the first indication information is a second value, it is indicated that the report result is a prediction result.
7. The method according to supplement 2, wherein the measurement result includes measured L1-RSRP or SINR, and the prediction result includes predicted L1-RSRP or SINR or a probability that a predicted beam (pair) is an optimal beam (pair).
8. An information transceiving method, applicable to a terminal equipment, characterized in that the method includes:
receiving reporting configuration transmitted by a network device; and
transmitting a reporting instance to the network device, the reporting instance including one or more reported results, a type of the one or more reported results including a measurement result and/or a prediction result.
9. The method according to supplement 8, wherein a type of one reported result or one group of reported results in the one or more reported results is predefined as a measurement result or a prediction result, and/or the reporting instance further includes reference signal identifiers corresponding to the reported results, and a type of a reported result corresponding to one reference signal identifier or one group of reference signal identifiers is predefined as a measurement result or a prediction result.
10. The method according to supplement 8, wherein the reporting instance further includes one or more second indication information, the one or more second indication information being used to indicate the type of the one or more reported results in the reporting instance transmitted by the terminal equipment.
11. The method according to supplement 10, wherein the reporting instance includes one second indication information, the one second indication information corresponding to one group of reported results or all reported results, or the reporting instance includes multiple second indication information, each second indication information in the multiple second indication information corresponding to a reported result, and the number of the second indication information is less than or equal to the number of the reported results, and/or
the reporting instance further includes reference signal identifiers corresponding to the reported results, and the reporting instance includes one second indication information, the one second indication information corresponding to one group of reference signal identifiers or all reference signal identifiers, or the reporting instance includes multiple second indication information, each second indication information in the multiple second indication information corresponding to a reference signal identifier, and the number of the second indication information is less than or equal to the number of the reference signal identifiers.
12. The method according to supplement 8, wherein the prediction result is obtained by an AI model deployed at a side of the terminal equipment.
13. The method according to supplement 8, wherein the measurement result includes measured L1-RSRP or SINR, and the prediction result includes predicted L1-RSRP or SINR or a probability that a predicted beam (pair) is an optimal beam (pair).
14. The method according to supplement 10, wherein when a value of the second indication information is a first value, it is indicated that corresponding one reported result or one group of reported results or all reported results or a reported result to which one reference signal identifier or one group of reference signal identifiers or all reference signal identifiers correspond(s) is/are a measurement result(s), and when the value of the second indication information is a second value, it is indicated that corresponding one reported result or one group of reported results or all reported results or a reported result to which one reference signal identifier or one group of reference signal identifiers or all reference signal identifiers correspond(s) is/are a prediction result(s).
15. The method according to supplement 10, wherein, when a value of the second indication information is a first value, it is indicated that corresponding one reported result or one group of reported results or all reported results or a reported result to which one reference signal identifier or one group of reference signal identifiers or all reference signal identifiers correspond(s) is/are a measurement result(s), and the remaining reported results or reported result to which the reference signal identifiers correspond are prediction results; or, when a value of the second indication information is a second value, it is indicated that corresponding one reported result or one group of reported results or all reported results or a reported result to which indicated one reference signal identifier or one group of reference signal identifiers or all reference signal identifiers correspond(s) is/are a prediction result(s), and the remaining reported results or reported result to which the reference signal identifiers correspond are measurement results.
16. The method according to supplement 8, wherein the reporting instance further includes a reference signal identifier, and a type of a reported result to which the reference signal identifier corresponds includes a measurement result, or a prediction result, or a measurement result and a prediction result.
17. The method according to supplement 8 or 10, wherein the reporting instance further includes group identifiers corresponding to the reported results, and/or group identifiers corresponding to the reference signal identifiers, types of reported results to which different groups of reported results and/or different groups of reference signal identifiers correspond being different.
18. The method according to supplement 8, wherein the method further includes:
receiving first indication information transmitted by the network device, the first indication information being used to indicate a type of one or more reported results in the reporting instance transmitted by the terminal equipment.
19. The method according to supplement 18, wherein the first indication information is carried by RRC signaling and/or an MAC CE and/or DCI.
20. An information transceiving method, applicable to a terminal equipment, characterized in that the method includes:
receiving first indication information transmitted by a network device, the first indication information being used to indicate a type of one or more reported results in a reporting instance transmitted by the terminal equipment; and
transmitting the reporting instance to the network device.
21. The method according to supplement 20, wherein the type of the reported result includes a measurement result or a prediction result.
22. The method according to supplement 20, wherein the prediction result is obtained by an AI model deployed at a side of the terminal equipment.
23. The method according to supplement 20, wherein the first indication information is carried by RRC signaling and/or an MAC CE and/or DCI.
24. The method according to supplement 20, wherein when the first indication information is received, it is indicated that the report result is a measurement result, and when the first indication information is not received, it is indicated that the report result is a prediction result; or, when the first indication information is not received, it is indicated that the report result is a measurement result, and when the first indication information is received, it is indicated that the report result is a prediction result; or, when the first indication information is received and a value of the first indication information is a first value, it is indicated that the report result is a measurement result, and when the first indication information is received and a value of the first indication information is a second value, it is indicated that the report result is a prediction result.
25. The method according to supplement 20, wherein the measurement result includes measured L1-RSRP or SINR, and the prediction result includes predicted L1-RSRP or SINR or a probability that a predicted beam (pair) is an optimal beam (pair).
26. The method according to supplement 20, wherein the reporting instance further includes one or more second indication information, the one or more second indication information being used to indicate type(s) of one or more reported results in the reporting instance transmitted by the terminal equipment.
27. The method according to supplement 26, wherein the reporting instance include one second indication information, the second indication information corresponding to one group of reported results or all reported results, or the reporting instance includes multiple second indication information, each second indication information in the multiple second indication information corresponding to a reported result, and the number of the second indication information being less than or equal to the number of the reported results, and/or,
the reporting instance further includes reference signal identifiers corresponding to the reported results, and the reporting instance includes one second indication information, the second indication information corresponding to one group of reference signal identifiers or all reference signal identifiers, or the reporting instance includes multiple second indication information, each second indication information in the multiple second indication information corresponding to a reference signal identifier, and the number of the second indication information being less than or equal to the number of the reference signal identifiers.
28. The method according to supplement 26, wherein when a value of the second indication information is a first value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are measurement result(s), and when a value of the second indication information is a second value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are prediction result(s).
29. The method according to supplement 26, wherein when the value of the second indication information is the first value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are measurement result(s), and the remaining reported results or the reported results to which the reference signal identifiers correspond are prediction results; or, when the value of the second indication information is the first value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are prediction result(s), and the remaining reported results or the reported results to which the reference signal identifiers correspond are measurement results.
30. The method according to supplement 20, wherein the reporting instance further includes reference signal identifiers, and a type of a reported result to which the reference signal identifiers correspond includes a measurement result or a prediction result.
31. The method according to supplement 20, wherein the reporting instance further includes group identifiers corresponding to the reported results and/or group identifiers corresponding to the reference signal identifiers, types of reported results to which different groups of reported results and/or different groups of reference signal identifiers correspond are different.
32. An information transceiving method, applicable to a network device, characterized in that the method includes:
transmitting a report configuration to a terminal equipment;
receiving a reporting instance transmitted by the terminal equipment, the reporting instance including one or more reported results, a type of the one or more reported results comprising a measurement result and/or a prediction result.
33. The method according to supplement 32, wherein a type of one reported result or one group of reported results in the one or more reported results is predefined as a measurement result or a prediction result, and/or the reporting instance further includes reference signal identifiers corresponding to the reported results, and a type of a reported result corresponding to one reference signal identifier or one group of reference signal identifiers is predefined as a measurement result or a prediction result.
34. The method according to supplement 32, wherein the reporting instance further includes one or more second indication information, the one or more second indication information being used to indicate the type of the one or more reported results in the reporting instance transmitted by the terminal equipment.
35. The method according to supplement 32, wherein the reporting instance includes one second indication information, the one second indication information corresponding to one group of reported results or all reported results, or the reporting instance includes multiple second indication information, each second indication information in the multiple second indication information corresponding to a reported result, and the number of the second indication information is less than or equal to the number of the reported results, and/or
the reporting instance further includes reference signal identifiers corresponding to the reported results, and the reporting instance includes one second indication information, the one second indication information corresponding to one group of reference signal identifiers or all reference signal identifiers, or the reporting instance includes multiple second indication information, each second indication information in the multiple second indication information corresponding to a reference signal identifier, and the number of the second indication information is less than or equal to the number of the reference signal identifiers.
36. The method according to supplement 32, wherein the prediction result is obtained by an AI model deployed at a side of the terminal equipment.
37. The method according to supplement 32, wherein the measurement result includes measured L1-RSRP or SINR, and the prediction result includes predicted L1-RSRP or SINR or a probability that a predicted beam (pair) is an optimal beam (pair).
38. The method according to supplement 34, wherein when a value of the second indication information is a first value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are measurement result(s), and when a value of the second indication information is a second value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are prediction result(s).
39. The method according to supplement 34, wherein the value of the second indication information is the first value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are measurement result(s), and the remaining reported results or the reported results to which the reference signal identifiers correspond are prediction results; or, when the value of the second indication information is the first value, it indicates that a corresponding reported result or a corresponding group of reported results or all corresponding reported results or a reported result/reported results to which one indicated reference signal identifier or an indicated group of reference signal identifiers or all indicated reference signal identifiers correspond(s) is/are prediction result(s), and the remaining reported results or the reported results to which the reference signal identifiers correspond are measurement results.
40. The method according to supplement 32, wherein the reporting instance further includes a reference signal identifier, and a type of a reported result to which the reference signal identifier corresponds includes a measurement result, or a prediction result, or a measurement result and a prediction result.
41. The method according to supplement 32 or 34, wherein the reporting instance further includes group identifiers corresponding to the reported results and/or group identifiers corresponding to the reference signal identifiers, types of reported results to which different groups of reported results and/or different groups of reference signal identifiers correspond are different.
42. The method according to supplement 32, wherein the method further includes:
transmitting first indication information to the terminal equipment, the first indication information being used to indicate a type of one or more reported results in a reporting instance transmitted by the terminal equipment.
43. The method according to supplement 42, wherein the first indication information is carried by RRC signaling and/or an MAC CE and/or DCI.
44. A network device, including a memory and a processor, the memory storing a computer program, and the processor being configured to execute the computer program to carry out the method as described in any one of supplements 1-7 and 32-43.
45. A terminal equipment, including a memory and a processor, the memory storing a computer program, and the processor being configured to execute the computer program to carry out the method as described in any one of supplements 8-31.

1. An information transceiving apparatus, applicable to a network device, the apparatus comprising:
a first transmitter configured to transmit first indication information to a terminal equipment or not to transmit first indication information to a terminal equipment, the first indication information being used to indicate a type of one or more reported results in a reporting instance transmitted by the terminal equipment; and
a first receiver configured to receive the reporting instance transmitted by the terminal equipment.

2. The apparatus according to claim 1, wherein the type of the reported result comprises a measurement result or a prediction result.

3. The apparatus according to claim 2, wherein the prediction result is obtained by an AI model deployed at a side of the terminal equipment.

4. The apparatus according to claim 1, wherein the first indication information is carried by RRC (radio resource control) signaling and/or an MAC (medium access control) CE (control element) and/or DCI (downlink control information).

5. The apparatus according to claim 1, wherein the reporting instance further comprises one or more second indication information, the one or more second indication information being used to indicate the type of the one or more reported results in the reporting instance transmitted by the terminal equipment.

6. The apparatus according to claim 1, wherein when the first indication information is transmitted, it is indicated that the report result is a measurement result, and when the first indication information is not transmitted, it is indicated that the report result is a prediction result; or, when the first indication information is not transmitted, it is indicated that the report result is a measurement result, and when the first indication information is transmitted, it is indicated that the report result is a prediction result; or, when the first indication information is transmitted and a value of the first indication information is a first value, it is indicated that the report result is a measurement result, and when the first indication information is transmitted and a value of the first indication information is a second value, it is indicated that the report result is a prediction result.

7. The apparatus according to claim 2, wherein the measurement result comprises measured L1-RSRP (reference signal receiving power) or SINR (signal to interference plus noise ratio), and the prediction result comprises predicted L1-RSRP or SINR or a probability that a predicted beam (pair) is an optimal beam (pair).

8. An information transceiving apparatus, applicable to a terminal equipment, the apparatus comprising:
a second receiver configured to receive reporting configuration transmitted by a network device; and
a second transmitter configured to transmit a reporting instance to the network device, the reporting instance comprising one or more reported results, a type of the one or more reported results comprising a measurement result and/or a prediction result.

9. The apparatus according to claim 8, wherein a type of one reported result or one group of reported results in the one or more reported results is predefined as a measurement result or a prediction result, and/or the reporting instance further comprises reference signal identifiers corresponding to the reported results, and a type of a reported result corresponding to one reference signal identifier or one group of reference signal identifiers is predefined as a measurement result or a prediction result.

10. The apparatus according to claim 8, wherein the reporting instance further comprises one or more second indication information, the one or more second indication information being used to indicate the type of the one or more reported results in the reporting instance transmitted by the terminal equipment.

11. The apparatus according to claim 10, wherein the reporting instance comprises one second indication information, the one second indication information corresponding to one group of reported results or all reported results, or the reporting instance includes multiple second indication information, each second indication information in the multiple second indication information corresponding to a reported result, and the number of the second indication information is less than or equal to the number of the reported results, and/or
the reporting instance further includes reference signal identifiers corresponding to the reported results, and the reporting instance includes one second indication information, the one second indication information corresponding to one group of reference signal identifiers or all reference signal identifiers, or the reporting instance includes multiple second indication information, each second indication information in the multiple second indication information corresponding to a reference signal identifier, and the number of the second indication information is less than or equal to the number of the reference signal identifiers.

12. The apparatus according to claim 8, wherein the prediction result is obtained by an AI model deployed at a side of the terminal equipment.

13. The apparatus according to claim 8, wherein the measurement result comprises measured L1-RSRP (reference signal receiving power) or SINR (signal to interference plus noise ratio), and the prediction result comprises predicted L1-RSRP or SINR or a probability that a predicted beam (pair) is an optimal beam (pair).

14. The apparatus according to claim 10, wherein when a value of the second indication information is a first value, it is indicated that corresponding one reported result or one group of reported results or all reported results or a reported result to which one reference signal identifier or one group of reference signal identifiers or all reference signal identifiers correspond(s) is/are a measurement result(s), and when the value of the second indication information is a second value, it is indicated that corresponding one reported result or one group of reported results or all reported results or a reported result to which one reference signal identifier or one group of reference signal identifiers or all reference signal identifiers correspond(s) is/are a prediction result(s).

15. The apparatus according to claim 10, wherein, when a value of the second indication information is a first value, it is indicated that corresponding one reported result or one group of reported results or all reported results or a reported result to which one reference signal identifier or one group of reference signal identifiers or all reference signal identifiers correspond(s) is/are a measurement result(s), and the remaining reported results or reported result to which the reference signal identifiers correspond are prediction results; or, when a value of the second indication information is a second value, it is indicated that corresponding one reported result or one group of reported results or all reported results or a reported result to which indicated one reference signal identifier or one group of reference signal identifiers or all reference signal identifiers correspond(s) is/are a prediction result(s), and the remaining reported results or reported result to which the reference signal identifiers correspond are measurement results.

16. The apparatus according to claim 8, wherein the reporting instance further comprises a reference signal identifier, and a type of a reported result to which the reference signal identifier corresponds comprises a measurement result, or a prediction result, or a measurement result and a prediction result.

17. The apparatus according to claim 8, wherein the reporting instance further comprises group identifiers corresponding to the reported results, and/or group identifiers corresponding to the reference signal identifier, types of reported results to which different groups of reported results and/or different groups of reference signal identifiers correspond being different.

18. The apparatus according to claim 8, wherein the second receiver is further configured to receive first indication information transmitted by the network device, the first indication information being used to indicate a type of one or more reported results in the reporting instance transmitted by the terminal equipment.

19. The apparatus according to claim 18, wherein the first indication information is carried by RRC (radio resource control) signaling and/or an MAC (medium access control) CE (control element) and/or DCI (downlink control information).

20. A communication system, comprising:
a network device that an information transceiving apparatus is applied to;
the information transceiving apparatus comprising:
a first transmitter configured to transmit first indication information to a terminal equipment or not to transmit first indication information to a terminal equipment, the first indication information being used to indicate a type of one or more reported results in a reporting instance transmitted by the terminal equipment; and
a first receiver configured to receive the reporting instance transmitted by the terminal equipment; and/or
a terminal equipment that an information transceiving apparatus is applied to;
the information transceiving apparatus comprising:
a second receiver configured to receive reporting configuration transmitted by a network device; and
a second transmitter configured to transmit a reporting instance to the network device, the reporting instance comprising one or more reported results, a type of the one or more reported results comprising a measurement result and/or a prediction result.
